(19) United States
(12) Patent Application Publication
(10) Pub. No.: US 2024/0356167 A1
(43) Pub. Date: Oct. 24, 2024

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuya IKEDA, Osaka (JP); Osamu NAKAYAMA, Osaka (JP); Nobuyuki MATSUMURA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/685,012

(22) PCT Filed: Aug. 25, 2022
(86) PCT No.: PCT/JP2022/032061

§ 371 Date: Feb. 20, 2024

(30) Foreign Application Priority Data
Sep. 9, 2021 (JP) 2021-146623

(51) Int. Cl. H01M 50/516; H01M 50/505; H01M 50/519

(52) U.S. Cl. CPC H01M 50/516; H01M 50/505; H01M 50/519

(57) ABSTRACT

A wiring module configured to be attached to a plurality of power storage elements having electrode terminals includes: a wire with a core wire; a wire relay member connected to the core wire with a first solder; a busbar configured to be connected to the electrode terminals; and a circuit board provided with a conductive path, the conductive path including a first land electrically connected to the busbar and a second land electrically connected to the wire relay member with a second solder.

### TECHNICAL FIELD

The technique disclosed in the present specification relates to a wiring module.

### BACKGROUND ART

Battery packs for use in electric automobiles, hybrid automobiles and the like are provided with a plurality of electric cells, a plurality of busbars that connect electrodes of the plurality of electric cells, and a sensing module (wiring module) for sensing voltages and the like of the electric cells, the sensing module being electrically connected to the busbars. Such wiring module includes a fuse unit in which, for example, a busbar connection terminal connected to a busbar, a wire connection terminal connected to a terminal portion of a wire, and a fuse connecting the busbar connection terminal and the wire connection terminal are formed as one piece (see Patent Document 1 below).

### CITATION LIST

### Patent Document

Patent Document 1: JP 2016-115616A

### SUMMARY OF INVENTION

### Technical Problem

In the above-described configuration, the fuse unit includes multiple components such as a synthetic resin housing that houses the busbar connection terminal, the wire connection terminal, and the fuse, thus causing a concern of a complicated configuration and an increase in manufacturing cost. In order to simplify the configuration of the wiring module and reduce the cost, it is conceivable to provide a circuit board that includes a conductive path with a land for busbars and a land for wires, and on which required electric components and the like are mounted, so that the busbars and the wires are connected to the respective lands. However, when the wire is directly connected to the land, there may be cases where due to, for example, floating of the wire from the land during soldering, connection strength cannot be ensured.

### Solution to Problem

The wiring module disclosed in the present specification is directed to a wiring module configured to be attached to a plurality of power storage elements having electrode terminals, the wiring module including: a wire with a core wire; a wire relay member connected to the core wire with a first solder; a busbar configured to be connected to the electrode terminals; and a circuit board provided with a conductive path, the conductive path including a first land electrically connected to the busbar and a second land electrically connected to the wire relay member with a second solder.

### Advantageous Effects of Invention

According to the wiring module disclosed in the present specification, it is possible to improve wire connection reliability.

### BRIEF DESCRIPTION OF DRAWINGS

FIG. 1 is a partially enlarged plan view of a power storage module of Embodiment 1.

FIG. 2 is a partially enlarged plan view illustrating the vicinity of a circuit board of a wiring module of Embodiment 1.

FIG. 3 is a partially enlarged perspective view illustrating the vicinity of a circuit board of the wiring module of Embodiment 1.

FIG. 4 is an enlarged exploded perspective view illustrating a board placement part, the circuit board, a busbar relay member, and a wire relay member of Embodiment 1.

FIG. 5 is a cross-sectional view taken along a line A-A in FIG. 2.

FIG. 6 is a cross-sectional view taken along a line B-B in FIG. 2.

FIG. 7 is a cross-sectional view taken along a line C-C in FIG. 2.

FIG. 8 is a partially enlarged perspective view illustrating the vicinity of a wire relay member of a wiring module of Embodiment 2.

FIG. 9 is a cross-sectional view taken along a line D-D in FIG. 8.

FIG. 10 is a partially enlarged perspective view illustrating the vicinity of a wire relay member of a wiring module of Embodiment 3.

FIG. 11 is a cross-sectional view taken along a line E-E in FIG. 10.

FIG. 12 is a partially enlarged perspective view illustrating the vicinity of a wire relay member of a wiring module of Embodiment 4.

FIG. 13 is a cross-sectional view taken along a line F-F in FIG. 12.

### DESCRIPTION OF EMBODIMENTS

### Overview of Embodiments

(1) The wiring module disclosed in the present specification is directed to a wiring module configured to be attached to a plurality of power storage elements having electrode terminals, the wiring module including: a wire with a core wire; a wire relay member connected to the core wire with a first solder; a busbar configured to be connected to the electrode terminals; and a circuit board provided with a conductive path, the conductive path including a first land electrically connected to the busbar and a second land electrically connected to the wire relay member with a second solder.

With the above-described configuration, by connecting the core wire to the land via the wire relay member, the degree of freedom in design for improving the connection strength is increased compared to a case where the core wire is directly connected to the land, resulting in an improvement in the connection reliability of the wire.

(2) In the wiring module according to the above-described item (1), the wire relay member may include a core wire connection part on which the core wire is placed, and a partitioning wall standing upright from the core wire connection part, the first solder may be disposed in a space formed by the core wire connection part and the partitioning wall, and the core wire may be embedded in the first solder.

With this configuration, as a result of the first solder being disposed with a certain degree of thickness in the space formed by the core wire connection part and the partitioning wall, and the core wire being embedded in the first solder, it is possible to ensure the connection strength.

(3) In the wiring module according to the above-described item (1) or (2), the first solder and the second solder may have different compositions, and may be disposed in a state in which they are not in contact with each other.

With this configuration, it is possible to avoid the first solder and the second solder, which have different compositions, from being mixed with each other and adversely affecting the electrical connection.

### Details of Embodiments

The following describes specific examples of the technique disclosed in the present specification with reference to the drawings. Note that the present invention is not limited to the examples but is defined by the claims, and all modifications within the meaning and scope equivalent to the claims are intended to be included.

### Embodiment 1

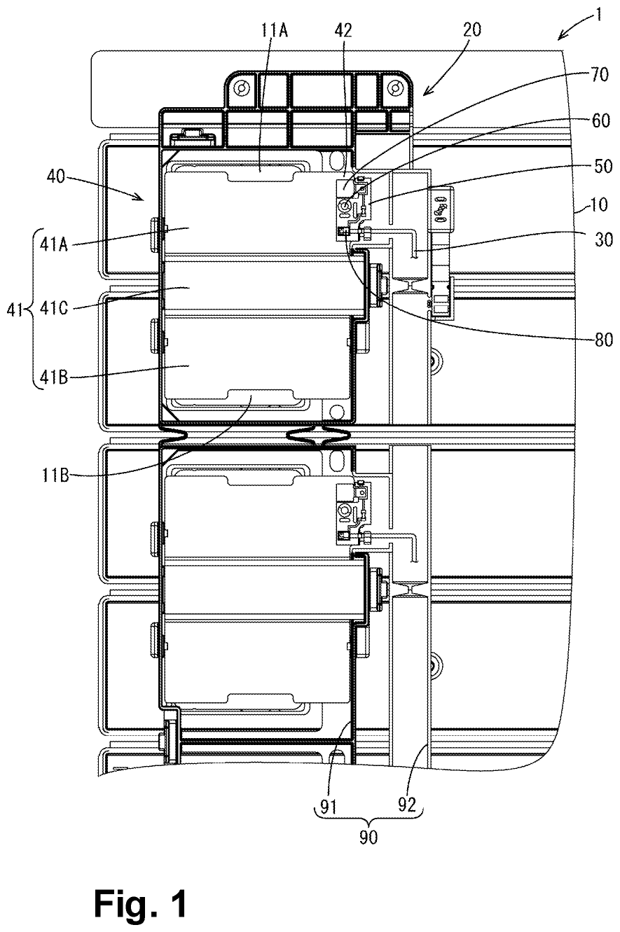

Embodiment 1 is described with reference to FIGS. 1 to 7. A power storage module 1 of the present embodiment is power source equipment that is used as a driving source for electric automobiles and hybrid automobiles, and includes, as shown in FIG. 1, a plurality of power storage elements 10 and a wiring module 20 connected to the power storage elements 10.

### Power Storage Element 10

The power storage elements 10 are secondary batteries. As shown in FIG. 1, each power storage element 10 is flat rectangular solid as a whole, and includes two electrode terminals 11A and 11B disposed on one face. One of the two electrode terminals 11A and 11B serves as a positive electrode terminal 11A, and the other one is a negative electrode terminal 11B. The plurality of power storage elements 10 are lined up in a line. Two adjacent power storage elements 10 are lined up so that the electrode terminals 11A and 11B having different polarities are adjacent to each other, that is, the positive electrode terminal 11A of one power storage element 10 and the negative electrode terminal 11B of the other power storage element 10 adjacent to the one power storage element 10 are adjacent to each other.

### Wiring Module 20

As shown in FIG. 1, the wiring module 20 includes a plurality of wires 30, a plurality of busbars 40, a plurality of circuit boards 50, a plurality of rivets 60 that respectively fix the circuit boards 50 to the busbars 40, a plurality of busbar relay members 70 that electrically connect the busbars 40 to the respective circuit boards 50, a plurality of wire relay members 80 that electrically connect the circuit boards 50 to the respective wires 30, and a holding member 90 that holds these members.

### Wire 30

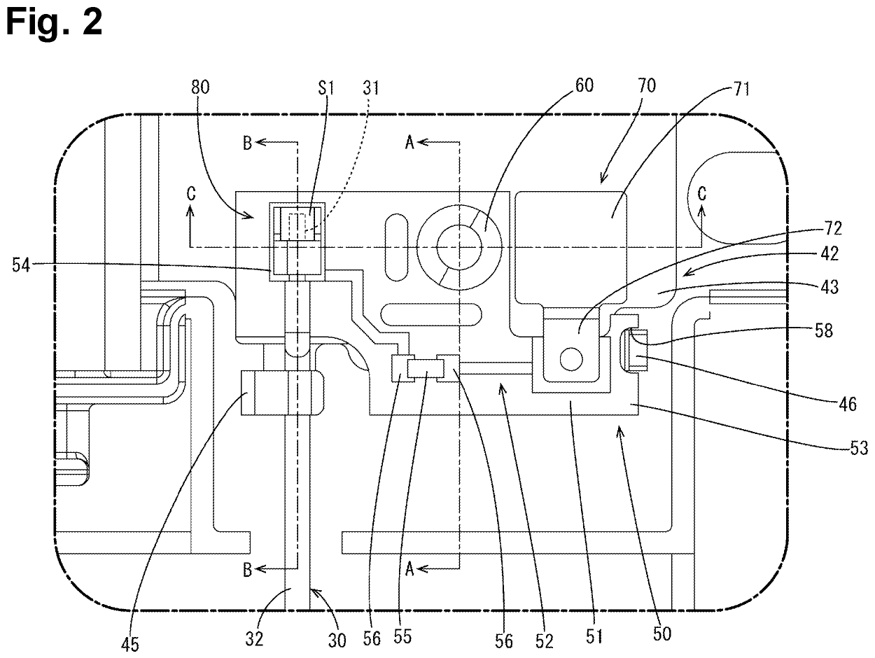

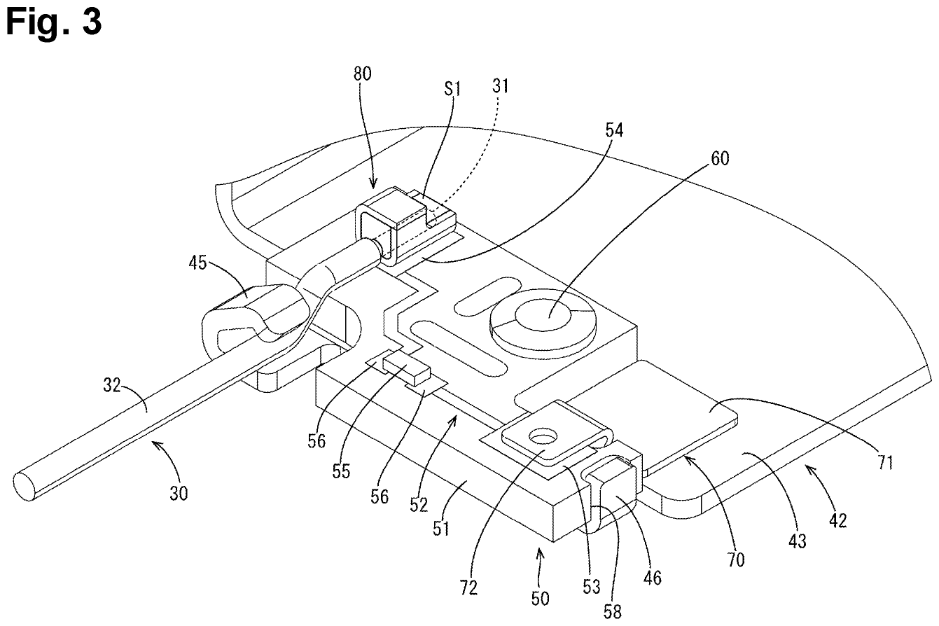

As shown in FIGS. 2 and 3, the wire 30 includes a core wire 31 and an insulating coating 32 that is made of a synthetic resin and encloses the outer circumference of the core wire 31. The core wire 31 is, for example, a single core wire made of a metal and is conductive. Examples of the material of the core wire 31 include copper, a copper alloy, aluminum, and an aluminum alloy. At one end of the wire 30, the insulating coating 32 is stripped and the core wire 31 is exposed. The other end of the wire 30 is connected to, for example, an external ECU (Electronic Control Unit) via a connector. ECUs are units on which a microcomputer, elements and the like are mounted, and have a well-known configuration having functions of, for example, sensing voltages, currents, temperatures and the like of the power storage elements 10, controlling charging/discharging of the power storage elements 10, and the like.

### Busbar 40

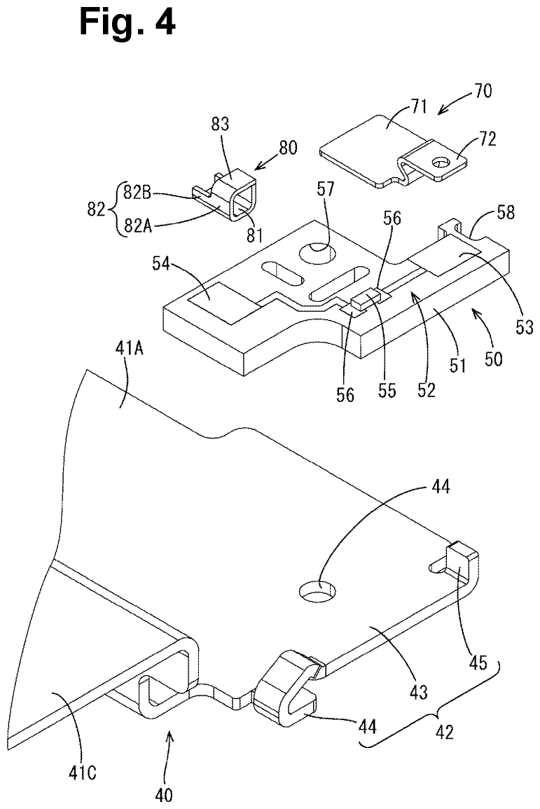

The busbars 40 are made of a metal, and are conductive. Examples of the material of the busbars 40 include copper, a copper alloy, aluminum, an aluminum alloy, and stainless steel (SUS). As shown in FIGS. 1 and 4, each busbar 40 includes a busbar main body 41 that connects the positive electrode terminal 11A of one power storage element 10 and the negative electrode terminal 11B of another power storage element 10 adjacent to the one power storage element 10, and a board placement part 42 that is contiguous to the busbar main body 41 and to which the corresponding circuit board 50 is fixed.

As shown in FIG. 1, the busbar main body 41 includes a first electrode connection part 41A that is plate-shaped and is laid on one of the electrode terminals 11A and 11B, a second electrode connection part 41B that is plate-shaped and is laid on the other electrode terminal, and a coupling part 41C that couples the first electrode connection part 41A and the second electrode connection part 41B. The first electrode connection part 41A and the second electrode connection part 41B are respectively connected to the electrode terminals 11A and 11B by, for example, laser welding.

As shown in FIG. 4, the board placement part 42 includes a board support part 43 that is contiguous to the first electrode connection part 41A and supports the circuit board 50, a wire holding part 45 that is contiguous to the board support part 43 and holds the wire 30, and a positioning projection 46 that extends from the board support part 43 and positions the circuit board 50. The board placement part 42 is plate-shaped, and has a first fixation hole 44. The first fixation hole 44 is a through hole through which the rivet 60 is passed. The wire holding part 45 is U-shaped as a whole, and is capable of receiving the wire 30 inside the U-shaped portion. The positioning projection 46 is a plate piece extending vertically with respect to the board support part 43.

### Circuit Board 50

As shown in FIGS. 2, 3 and 4, the circuit board 50 includes an insulating plate 51, and a conductive path 52 disposed on one face of the insulating plate 51. The insulating plate 51 is a hard plate made of, for example, a glass fabric base epoxy resin, and is insulating. The conductive path 52 is made of, for example, a conductive metal such as copper or a copper alloy, and is formed using printed wiring technique. A part of the conductive path 52 serves as a first land 53 connected to the busbar 40 via a later-described busbar relay member 70, and another part of the conductive path 52 serves as a second land 54 connected to the wire 30. A chip fuse 55 is connected to the conductive path 52 at a position between the first land 53 and the second land 54. The conductive path 52 includes two third lands 56 between the first land 53 and the second land 54, and two terminal portions of the chip fuse 55 are respectively connected to the two third lands 56 by soldering. Most part of the conductive path 52 except for the first land 53, the second land 54, and the two third lands 56 is covered with an insulating film made of a synthetic resin.

The insulating plate 51 has a second fixation hole 57 and a positioning recess 58. The second fixation hole 57 is a through hole through which the rivet 60 is passed. The positioning recess 58 is a recess that is recessed from the outer edge of the insulating plate 51, and is capable of receiving the positioning projection 46. As a result of the positioning projection 46 being received inside the positioning recess 58, the circuit board 50 is positioned with respect to the board support part 43.

### Rivet 60

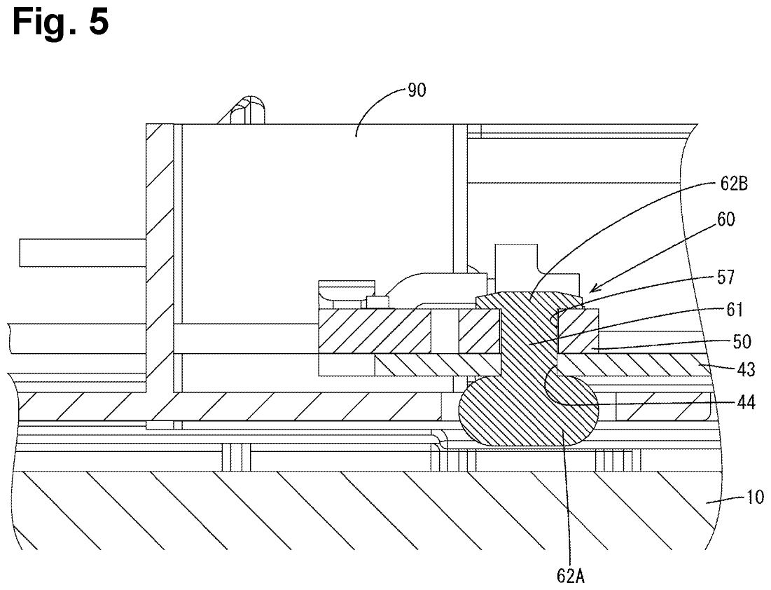

The rivet 60 is made of a metal, and includes, as shown in FIG. 5, a shaft portion 61 inserted into the first fixation hole 44 and the second fixation hole 57, and two head portions 62A and 62B that are formed at both ends of the shaft portion 61 and have diameters greater than the hole diameters of the first fixation hole 44 and the second fixation hole 57. The circuit board 50 is laid to overlap the board support part 43, the shaft portion 61 is inserted into the first fixation hole 44 and the second fixation hole 57, and the two head portions 62A and 62B are arranged with part of the board support part 43 around the first fixation hole 44 and part of the board support part 50 around the second fixation hole 57 interposed therebetween. With this, the circuit board 50 is fixed to the board support part 43.

### Busbar Relay Member 70

The busbar relay member 70 is a conductive plate material made of a metal, and has, as shown in FIGS. 2, 3 and 4, one end portion serving as a busbar connection part 71, and another end portion serving as a land connection part 72. The busbar connection part 71 is connected to the busbar 40 by welding, for example. The land connection part 72 is connected to the first land 53 by soldering.

### Wire Relay Member 80

The wire relay member 80 is made of a conductive metal, and includes, as shown in FIG. 4, a rectangular plate-shaped core wire connection part 81, two partitioning walls 82 standing upright from two parallel side edges of the core wire connection part 81, and a top wall 83 that faces the core wire connection part 81 and connects the two partitioning walls 82. The two partitioning walls 82 face each other. One half of each partitioning wall 82 that is adjacent to an end of the core wire connection part 81 is defined as a high-wall portion 82A, and the remaining half is defined as a low-wall portion 82B, which is lower than the high-wall portion 82A. The top wall 83 is bridged between the two high-wall portions 82A.

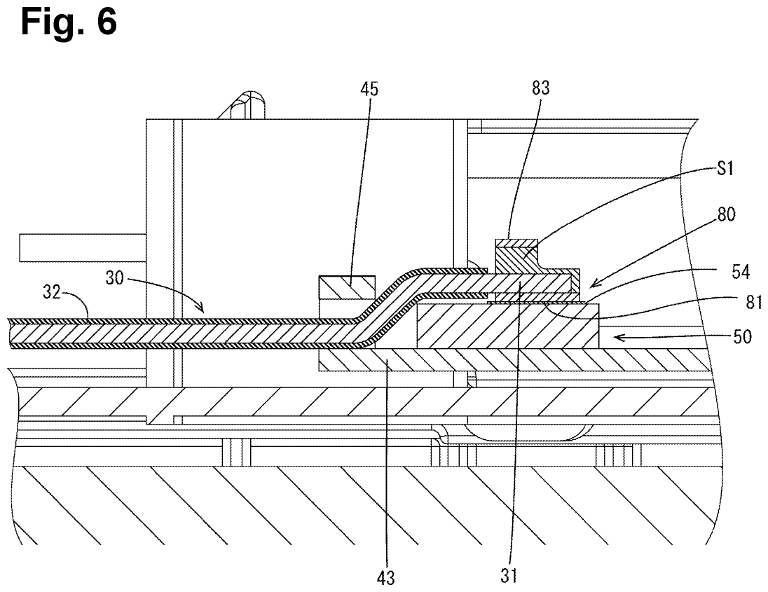

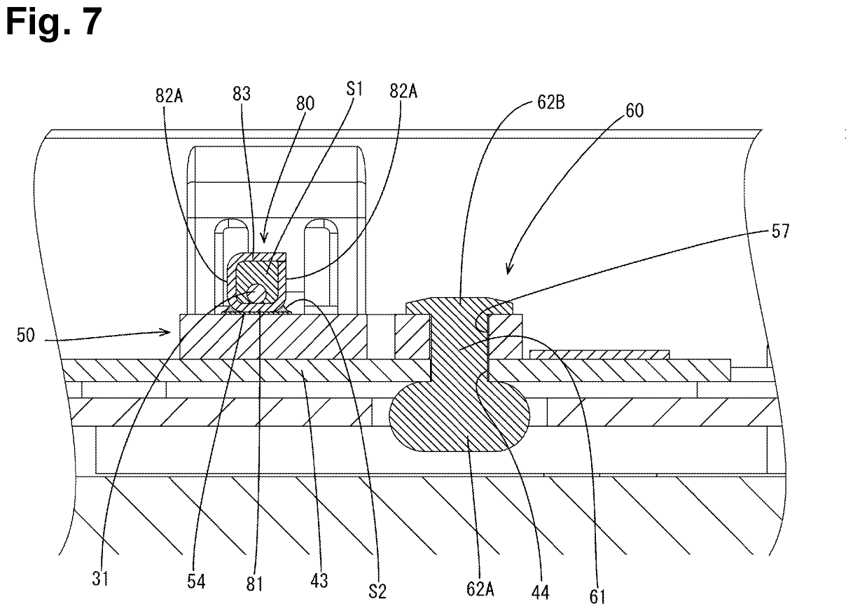

As shown in FIGS. 6 and 7, the core wire 31 exposed from the insulating coating 32 at a terminal portion of the wire 30 is placed on the core wire connection part 81, and the core wire 31 is connected to the core wire connection part 81 by soldering. In the following description, a solder that connects the core wire 31 to the core wire connection part 81 is referred to as a first solder S1. The first solder S1 is disposed in a space of the wire relay member 80 that is surrounded by the core wire connection part 81 and the two partitioning walls 82, and the core wire 31 is embedded in the first solder S1. The first solder S1 is disposed with a certain degree of thickness between the two partitioning walls 82, and the core wire 31 is embedded in the first solder S1. Particularly, the wire relay member 80 has a tubular portion surrounded by the core wire connection part 81, the two high-wall portions 82A, and the top wall 83, and the tubular portion is filled with the first solder S1. With this, the core wire 31 is reliably embedded in the first solder S1, so that the core wire 31 is covered with the first solder S1 over the entire circumference.

The wire relay member 80 is disposed on the second land 54 in an orientation in which the core wire connection part 81 overlaps the second land 54, and is connected to the second land 54 by soldering. The solder with which the core wire connection part 81 connects the wire relay member 80 to the second land 54 is a second solder S2, which has a different composition from that of the first solder S1. As a result of the core wire 31 being connected to the wire relay member 80 with the first solder S1, and the wire relay member 80 being connected to the second land 54 with the second solder S2, the wire 30 is connected to the conductive path 52 via the wire relay member 80. Since the first solder S1 and the second solder S2 have different compositions, they are preferably in a state in which they are not mixed with each other, that is, they are not in contact with each other. This is to avoid a reduction in connection reliability. The partitioning walls 82 also have a shielding function of preventing the first solder S1 from being mixed with the second solder S2.

### Holding Member 90

The holding member 90 is made of a synthetic resin, and includes, as shown in FIG. 1, a busbar holding part 91 that holds the plurality of busbars 40, and a wire routing part 92 in which the wires 30 are routed.

### Method for Manufacturing Power Storage Module 1

The following will describe an example of a method for manufacturing the power storage module 1 having the above-described configuration.

First, the circuit board 50 is manufactured using a printed wiring technique. Then, the second solders S2 are applied to the first land 53, the second land 54, and the third lands 56 of the circuit board 50, and the land connection part 72 of the busbar relay member 70, the wire relay member 80, and the chip fuse 55 are connected, by reflow soldering, to the first land 53, the second land 54, and the third lands 56, respectively.

Then, the circuit board 50 to which the wire relay member 80, the busbar relay member 70 and the chip fuse 55 are connected is placed on the board support part 43. At this time, the positioning projection 46 is received inside the positioning recess 58, and the circuit board 50 is thus positioned. In this state, the circuit board 50 is fixed to the board placement part 42 by the rivet 60. The rivet 60 before fixation does not have any head portion 62B, and by inserting the shaft portion 61 through the first fixation hole 44 and the second fixation hole 57, and then punching the leading end portion of the shaft portion 61, the head portion 62B is formed. Subsequently, the busbar connection part 71 is connected to the busbar 40 by welding. With this, the busbar 40 and the first land 53 are electrically connected to each other via the busbar relay member 70.

Then, the plurality of busbars 40 to each of which the circuit board 50 is fixed are set in the busbar holding part 91 of the holding member 90. Then, the wires 30 are routed in the wire routing part 92 of the holding member 90, and the core wire 31 exposed at a terminal portion of each wire 30 is placed on the corresponding core wire connection part 81. The part of the wire 30 that is covered with the insulating coating 32 and is adjacent to the exposed portion of the core wire 31 is inserted into and held by the corresponding wire holding part 45. In this state, using, for example, a robot soldering apparatus, the core wire 31 is connected to the wire relay member 80 with the first solder S1. With this, the manufacturing of the wiring module 20 is complete.

Eventually, the wiring module 20 is disposed on the plurality of power storage elements 10, and the busbars 40 are connected to the electrode terminals 11A and 11B by laser welding. With this, the manufacturing of the power storage module 1 is complete.

### Operational Effects

As described above, according to the present embodiment, a wiring module 20 to be attached to a plurality of power storage elements 10 having electrode terminals 11A and 11B includes: a wire 30 with a core wire 31; a wire relay member 80 connected to the core wire 31 with a first solder S1; a busbar 40 configured to be connected to the electrode terminals 11A, 11B; and a circuit board 50 provided with a conductive path 52, the conductive path 52 including a first land 53 electrically connected to the busbar 40 and a second land 54 electrically connected to the wire relay member 80 with a second solder S2.

With the above-described configuration, by connecting the core wire 31 to the second land 54 via the wire relay member 80, the degree of freedom in design for improving the connection strength is increased compared to a case where the core wire is directly connected to the land, resulting in an improvement in the connection reliability of the wire 30.

Also, the wire relay member 80 includes a core wire connection part 81 on which the core wire 31 is placed, and a partitioning wall 82 that stands upright from the core wire connection part 81, the first solder S1 is disposed in a space formed by the core wire connection part 81 and the partitioning wall 82, and the core wire 31 is embedded in the first solder S1.

With this configuration, the first solder S1 is disposed with a certain degree of thickness in the space formed by the core wire connection part 81 and the partitioning wall 82, and the core wire 31 is embedded in the first solder S1, making it possible to ensure connection strength.

Also, the first solder S1 and the second solder S2 have different compositions, and are disposed in a state in which they are not in contact with each other.

With this configuration, it is possible to avoid the first solder S1 and the second solder S2, which have different compositions, from being mixed with each other and adversely affecting the electrical connection.

### Embodiment 2

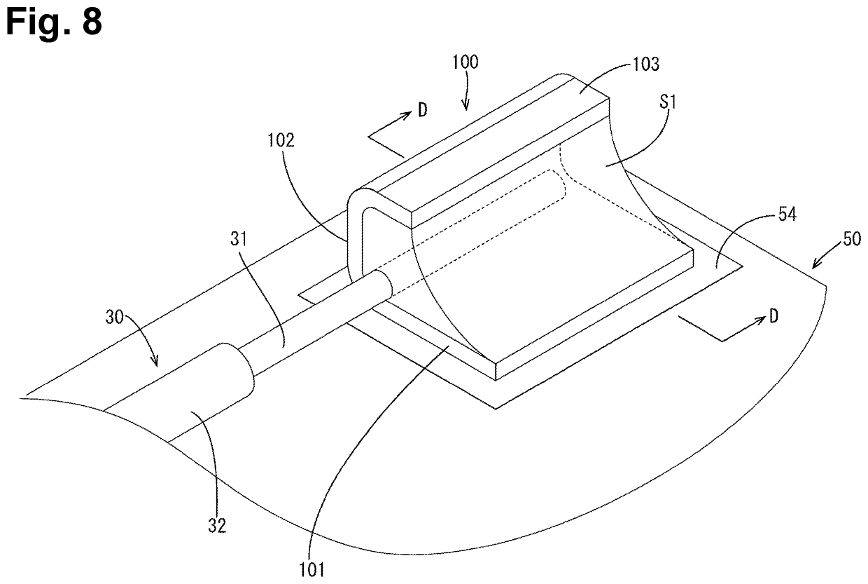

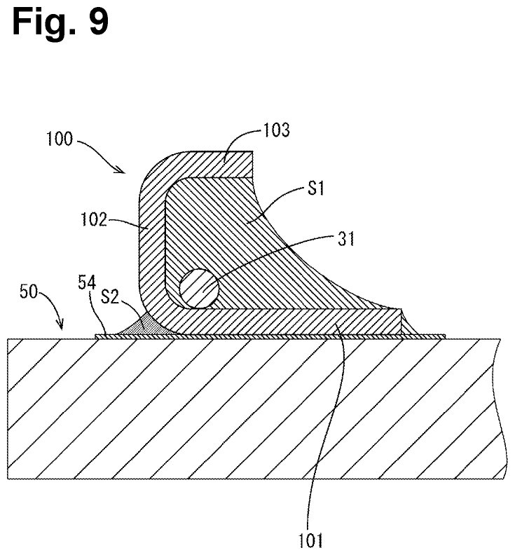

The following will describe Embodiment 2 with reference to FIGS. 8 and 9. The present embodiment differs from Embodiment 1 in the configuration of a wire relay member 100. In the present embodiment, the same reference numerals are given to the same configurations as those in Embodiment 1, and descriptions thereof are omitted.

The wire relay member 100 is made of a conductive metal, and includes a rectangular plate-shaped core wire connection part 101 laid on the second land 54, a partitioning wall 102 standing upright from one side edge of the core wire connection part 101, and a top wall 103 that extends from an extended end of the partitioning wall 102, and faces the core wire connection part 101.

The core wire 31 exposed from the insulating coating 32 at a terminal portion of the wire 30 is placed on the core wire connection part 101, and the core wire 31 is connected to the wire relay member 100 with the first solder S1. The protruding length of the top wall 103 is less than or equal to one half of the partitioning wall 102, so that soldering can be easily performed by inserting a soldering iron into a gap between the core wire connection part 101 and the top wall 103. On the wire relay member 100, the first solder S1 is disposed in a space surrounded by the core wire connection part 101 and the partitioning wall 102 and the top wall 103. With this, the first solder S1 is disposed with a certain degree of thickness, and the core wire 31 is embedded in the first solder S1, thereby ensuring the connection strength.

Similar to the above-described embodiment, the wire relay member 100 is disposed on the second land 54 in a manner such that the core wire connection part 101 overlaps the second land 54, and is connected to the second land 54 with the second solder S2. Since the first solder S1 and the second solder S2 have different compositions, it is preferable that they are not mixed with each other, and are not in contact with each other. The partitioning wall 102 also has a shielding function of preventing the first solder S1 from being mixed with the second solder S2 at one side edge (left side edge in FIG. 9) of the core wire connection part 101. Also, since no partitioning wall 102 is provided on the other side edge of the core wire connection part 101, it is conceivable that, as shown in FIG. 9, the first solder S1 runs over the second land 54 beyond the other side edge of the core wire connection part 101. Accordingly, to prevent the first solder S1 and the second solder S2 from being mixed with each other, it is preferable that the region of the second land 54 that is adjacent to the other side edge (at which no partitioning wall 102 is provided) of the core wire connection part 101 is defined as a region free from the second solder S2.

### Embodiment 3

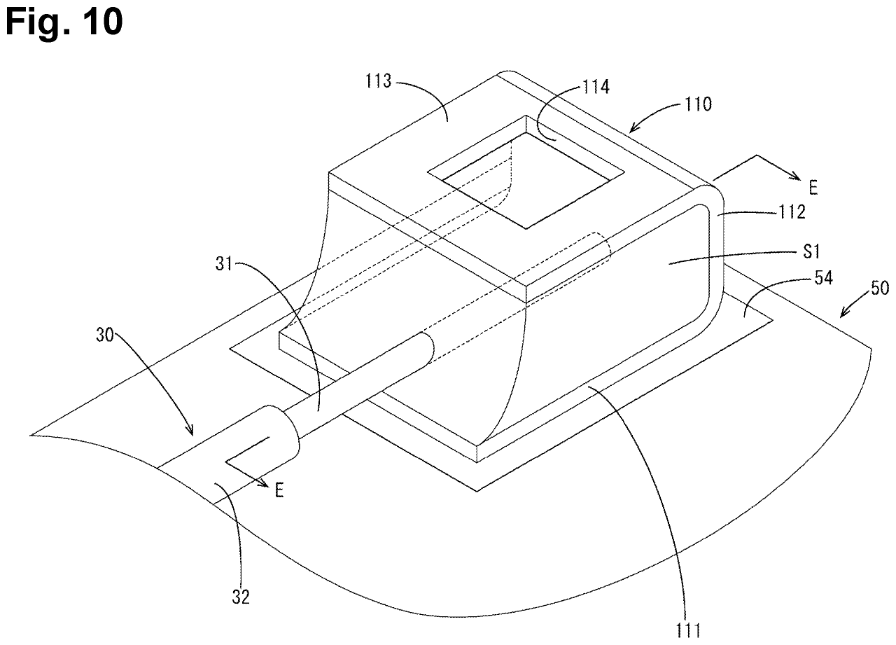

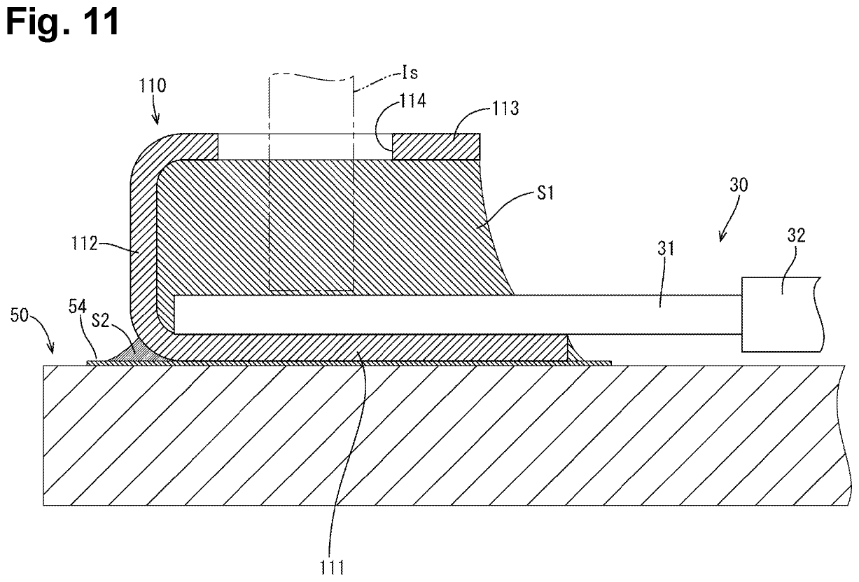

The following will describe Embodiment 3 with reference to FIGS. 10 and 11. The present embodiment differs from Embodiment 1 in the configuration of a wire relay member 110. In the present embodiment, the same reference numerals are given to the same configurations as those in Embodiment 1, and descriptions thereof are omitted.

The wire relay member 110 is made of a conductive metal, and includes a rectangular plate-shaped core wire connection part 111 laid on the second land 54, a partitioning wall 112 standing upright from one side edge of the core wire connection part 111, and a top wall 113 that extends from an extended end of the partitioning wall 112, and faces the core wire connection part 111.

The core wire 31 exposed from the insulating coating 32 at a terminal portion of the wire 30 is placed on the core wire connection part 111, and the core wire 31 is connected to the wire relay member 110 with the first solder S1. On the wire relay member 110, the first solder S1 is disposed in a space surrounded by the core wire connection part 111 and the partitioning wall 112 and the top wall 113. With this, the first solder S1 is disposed with a certain degree of thickness, and the core wire 31 is embedded in the first solder S1. The protruding length of the top wall 113 is about equal to or slightly smaller than the partitioning wall 82, so that a larger amount of first solder S1 is disposed in the space surrounded by the core wire connection part 111 and the partitioning wall 112 and the top wall 113. With this, the core wire 31 is reliably embedded in the first solder S1, and connection strength is ensured.

The top wall 113 has a soldering iron insertion hole 114. The soldering iron insertion hole 114 is a through hole through which a soldering iron Is is to be passed. Soldering can easily be performed by inserting the soldering iron Is into the soldering iron insertion hole 114.

Similar to the above-described embodiment, the wire relay member 110 is disposed on the second land 54 in a manner such that the core wire connection part 111 overlaps the second land 54, and is connected to the second land 54 with the second solder S2. Since the first solder S1 and the second solder S2 have different compositions, it is preferable that they are not mixed with each other, and are not in contact with each other. The partitioning wall 112 also has a shielding function of preventing the first solder S1 from being mixed with the second solder S2 at one side edge (left side edge in FIG. 9) of the core wire connection part 111. Also, since no partitioning wall 112 is provided on the other side edge of the core wire connection part 111, it is conceivable that, as shown in FIG. 11, the first solder S1 runs over the second land 54 beyond the other side edge of the core wire connection part 111. Accordingly, to prevent the first solder S1 and the second solder S2 from being mixed with each other, it is preferable that the region of the second land 54 that is adjacent to the other side edge (at which no partitioning wall 112 is provided) of the core wire connection part 111 is defined as a region free from the second solder S2.

### Embodiment 4

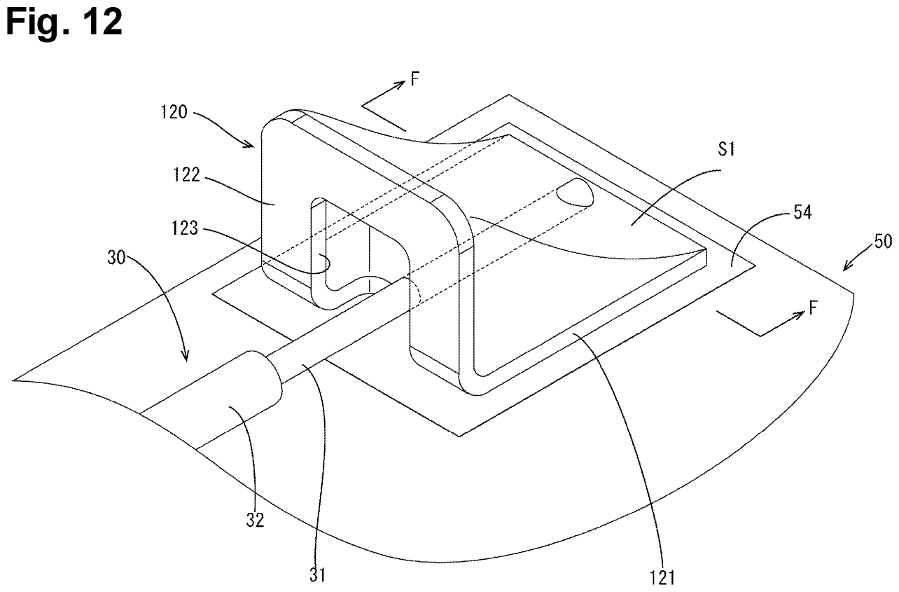

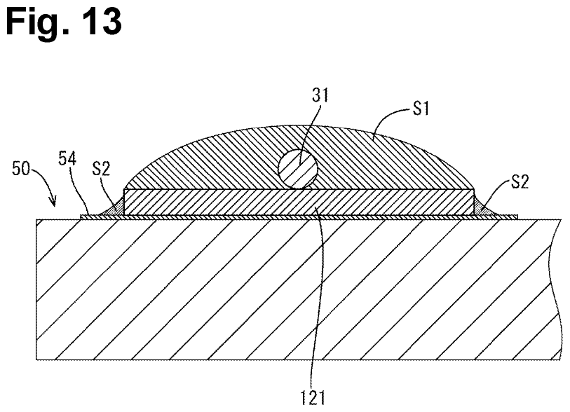

The following will describe Embodiment 4 with reference to FIGS. 12 and 13. The present embodiment differs from Embodiment 1 in the configuration of a wire relay member 120. In the present embodiment, the same reference numerals are given to the same configurations as those in Embodiment 1, and descriptions thereof are omitted.

The wire relay member 120 is made of a conductive metal, and includes a rectangular plate-shaped core wire connection part 121 laid on the second land 54, and a wire insertion wall 122 standing upright from one side edge of the core wire connection part 121. The wire insertion wall 122 has a wire insertion hole 123. The wire insertion hole 123 is a through hole through which the wire 30 can be passed.

The core wire 31 exposed from the insulating coating 32 at a terminal portion of the wire 30 is inserted into the wire insertion hole 123, is placed on the core wire connection part 121, and is connected to the wire relay member 120 with the first solder S1. The first solder S1 is raised in a mountain shape on the core wire connection part 121, and the core wire 31 is embedded in the first solder S1. With this, connection strength is ensured.

Similar to the above-described embodiment, the wire relay member 120 is disposed on the second land 54 in a manner such that the core wire connection part 121 overlaps the second land 54, and is connected to the second land 54 with the second solder S2. The first solder S1 is disposed only on the core wire connection part 121 so as not to be in contact with the second solder S2.

### Other Embodiments

(1) In the above-described embodiments, the core wire 31 is a single-core wire, but the core wire may be a twisted wire obtained by twisting a plurality of bare wires together.
(2) In the above-described embodiments, the circuit board 50 is fixed to the busbar 40 using the rivet 60, but a means for fixing the circuit board to the busbar is not limited to the means described in the above-described embodiments, and may be, for example, a screw, adhesive or the like.

### LIST OF REFERENCE NUMERALS

1: Power storage module
10: Power storage element
11A: Positive electrode terminal (electrode terminal)
11B: Negative electrode terminal (electrode terminal)
20: Wiring module
30: Wire
31: Core wire
32: Insulating coating
40: Busbar
41: Busbar main body
41A: First electrode connection part
41B: Second electrode connection part
41C: Coupling part
42: Board placement part
43: Board support part
44: First fixation hole
45: Wire holding part
46: Positioning projection
50: Circuit board
51: Insulating plate
52: Conductive path
53: First land
54: Second land
55: Chip fuse
56: Third land
57: Second fixation hole
58: Positioning recess
60: Rivet
61: Shaft portion
62A, 62B: Head portion
70: Busbar relay member
71: Busbar connection part
72: Land connection part
80, 100, 110, 120: Wire relay member
81, 101, 111, 121: Core wire placement part
82, 102, 112: Partitioning wall
82A: High-wall portion
82B: Low-wall portion
83, 103, 113: Top wall
90: Holding member
91: Busbar holding part
92: Wire routing part
114: Soldering iron insertion hole
122: Wire insertion wall
123: Wire insertion hole
Is: Soldering iron
S1: First solder
S2: Second solder

1. A wiring module configured to be attached to a plurality of power storage elements having electrode terminals, the wiring module comprising:
a wire with a core wire;
a wire relay member connected to the core wire with a first solder;
a busbar configured to be connected to the electrode terminals; and
a circuit board provided with a conductive path, the conductive path including a first land electrically connected to the busbar and a second land electrically connected to the wire relay member with a second solder.

2. The wiring module according to claim 1,
wherein the wire relay member includes a core wire connection part on which the core wire is placed, and a partitioning wall that stands upright from the core wire connection part,
the first solder is disposed in a space formed by the core wire connection part and the partitioning wall, and
the core wire is embedded in the first solder.

3. The wiring module according to claim 1,
wherein the first solder and the second solder have different compositions, and are disposed in a state in which they are not in contact with each other.

4. The wiring module according to claim 2,
wherein the first solder and the second solder have different compositions, and are disposed in a state in which they are not in contact with each other.
